(19) United States
(12) Patent Application Publication
(10) Pub. No.: US 2024/0166166 A1
(43) Pub. Date: May 23, 2024

(54) VEHICLE HVAC SYSTEM

(71) Applicant: DENSO International America, Inc., Southfield, MI (US)

(72) Inventors: Brian BELANGER, Farmington Hills, MI (US); Aaron COMPTON, Pinckney, MI (US); Dwayne TAYLOR, Livonia, MI (US); Michael BIMA, Milford, MI (US); Andrew TARNACKI, Farmington Hills, MI (US); Jonathan NOAH-NAVARRO, Royal Oak, MI (US); Bruce BARNARD, Novi, MI (US); Chris PAQUETTE, Ferndale, MI (US)

(73) Assignee: DENSO International America, Inc., Southfield, MI (US)

(21) Appl. No.: 18/513,482

(22) Filed: Nov. 17, 2023

Related U.S. Application Data
(60) Provisional application No. 63/426,555, filed on Nov. 18, 2022.

(51) Int. Cl. B60S 1/02; B60H 1/32

(52) U.S. Cl. CPC B60S 1/026; B60H 1/3229

(57) ABSTRACT

An HVAC system for a vehicle including: a transparent metallic layer configured to be mounted to a windshield; a control module configured to apply voltage from a power supply to the transparent metallic layer to heat the windshield; and an HVAC case defining a face outlet and a combined foot and side window outlet, the HVAC case including a mode door movable to control airflow through both the face outlet and the combined foot and side window outlet.

### CROSS-REFERENCE TO RELATED APPLICATION

This application claims the benefit of U.S. Provisional Application No. 63/426,555 filed on Nov. 18, 2022, the entire disclosure of which is incorporated herein by reference.

### FIELD

The present disclosure relates to a heating, ventilation, and air conditioning (HVAC) for a vehicle.

### BACKGROUND

This section provides background information related to the present disclosure, which is not necessarily prior art.

Traditionally, vehicle windshields are defrosted, deiced, and/or defogged by directing a flow of hot air from vents of an HVAC system of the vehicle to the windshield to heat the glass. Ice or frost formed on the windshield is then melted by the heat from the glass of the windshield as it is heated by the hot airflow from the vents of the HVAC system. Similarly, any fog on the windshield dissipates as the glass is warmed to a temperature above the current dew point of the vehicle environment. Defrosting, deicing, and/or defogging the vehicle windshield using hot air from the HVAC system, however, can take a large amount of time and can consume a large amount of energy. For example, defrosting a vehicle windshield using hot air from the HVAC system can take 20 to 30 minutes and can consume 5.2 kilowatt-hours (kWh) of energy. As such, faster and more energy efficient methods and systems are needed.

### SUMMARY

This section provides a general summary of the disclosure, and is not a comprehensive disclosure of its full scope or all of its features.

The present disclosure provides for an HVAC system for a vehicle including: a transparent metallic layer configured to be mounted to a windshield; a control module configured to apply voltage from a power supply to the transparent metallic layer to heat the windshield; and an HVAC case defining a face outlet and a combined foot and side window outlet, the HVAC case including a mode door movable to control airflow through both the face outlet and the combined foot and side window outlet.

The present disclosure further provides for an HVAC system for a vehicle including: a transparent metallic layer mounted to a windshield; a control module configured to apply voltage from a power supply to the transparent metallic layer to heat the windshield; an HVAC case defining a face outlet and a combined foot and side window outlet that is adjacent to the face outlet; a mode door opposite to the face outlet and the combined foot and side window outlet, the mode door movable to control airflow through both the face outlet and the combined foot and side window outlet; an evaporator and a heater core within the HVAC case; and at least one air mix door between the evaporator and the heater core.

The present disclosure also provides for an HVAC system for a vehicle including: a transparent metallic layer mounted to a windshield; a control module configured to apply voltage from a power supply to the transparent metallic layer to heat the windshield; an HVAC case defining a face outlet and a combined foot and side window outlet that is adjacent to the face outlet; a mode door opposite to the face outlet and the combined foot and side window outlet, the mode door movable to control airflow through both the face outlet and the combined foot and side window outlet; an evaporator and a heater core within the HVAC case; and at least one air mix door between the evaporator and the heater core. The combined foot and side window outlet is in fluid communication with a side window opening by way of a first conduit, and in fluid communication with a foot opening by way of a second conduit. The HVAC case is devoid of a windshield defrost outlet.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary electrical heating system in accordance with the present disclosure for electrically heating a windshield or other glass surface of a vehicle;

FIG. 2 illustrates an exemplary vehicle including the electrical heating system of the present disclosure;

FIG. 3 illustrates layers of an exemplary windshield including a transparent metallic layer in accordance with the present disclosure;

FIG. 4 illustrates an exemplary HVAC system, the electrical heating system of the present disclosure configured to heat components of the HVAC system;

FIG. 5 illustrates an HVAC case in accordance with the present disclosure;

FIG. 6 is a cross-sectional view of the HVAC case of FIG. 6;

FIG. 7 is a cross-sectional view of an additional HVAC case in accordance with the present disclosure;

FIG. 8 is an exterior, plan view of the HVAC case of FIG. 7;

FIG. 9 illustrates an additional HVAC system in accordance with the present disclosure;

FIG. 10 illustrates an exemplary system in accordance with the present disclosure for delivering airflow to a cabin by way of a head liner;

FIG. 11 is a cross-sectional view of an additional HVAC case in accordance with the present disclosure; and

FIG. 12 is a cross-sectional view of yet another HVAC case in accordance with the present disclosure.

Corresponding reference numerals indicate corresponding parts throughout the several views of the drawings.

### DETAILED DESCRIPTION

Example embodiments will now be described more fully with reference to the accompanying drawings.

The present disclosure includes systems and methods for defrosting, deicing, and/or defogging a vehicle windshield and/or other glass surfaces (e.g., side windows, rear window, glass roof, etc.) by running electrical current through, or otherwise across, the windshield and/or other glass surfaces. Any suitable system for applying electrical current may be used, such as, but not limited to, a pulse-electro thermal deicing (PETD) heater system. The present disclosure applies to heating vehicle glass, as well as non-vehicular glass. The present disclosure is thus not limited to automotive applications. The present disclosure applies to any glass surfaces in need of defogging, deicing, defrosting, etc.

The present disclosure includes systems and methods configured to quickly and efficiently defrost, deice, and/or defog a vehicle windshield by heating the windshield through the application of a voltage to a transparent metallic layer of the windshield. The heat may be generated by a PETD heater system or any other suitable system configured to direct electrical current through or otherwise across a vehicle windshield and/or any other glass surfaces. Heat generated by the electrical current running through the transparent metallic layer of the windshield heats the windshield to defrost, deice, and/or defog the vehicle windshield. For example, the PETD heater system can quickly heat the windshield and melt a layer of ice formed on the windshield causing the remaining ice on the windshield to be separated from the windshield by a layer of water. Once the layer of water has formed between the windshield and the remaining ice on the windshield, the windshield wipers of the vehicle can be activated to brush the remaining ice off the windshield. In one embodiment, for example, defrosting a windshield using a PETD heater system in accordance with the present disclosure can take less than one minute and can consume 0.12 kWh of energy. Compared with the 20-30 minutes and 5.2 kWh required for a traditional system using hot air flow from an HVAC system, the PETD heater system can provide significant time and energy savings.

PETD heater systems and related concepts are shown and described in the following patents, which are incorporated herein by reference in their entirety: U.S. Pat. No. 6,870,139, titled “Systems and methods for modifying an ice-to-object interface”; U.S. Pat. No. 8,921,739, titled “Systems and methods for windshield deicing”; U.S. Pat. No. 10,473,381 “High-frequency self-defrosting evaporator coil”; U.S. Pat. No. 11,229,091, titled “Continuous resistance and proximity checking for high power deicing and defogging systems.”

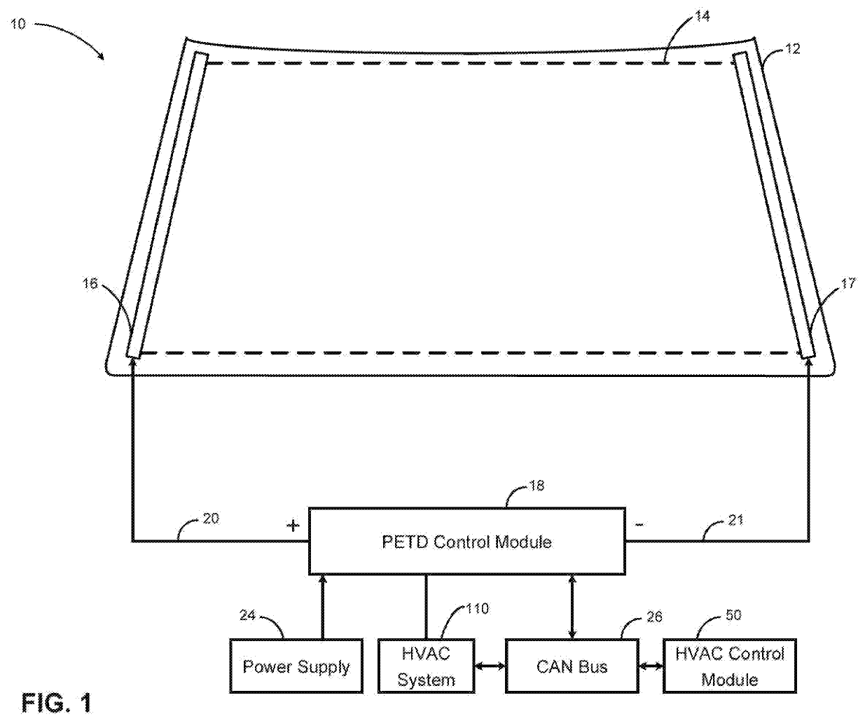

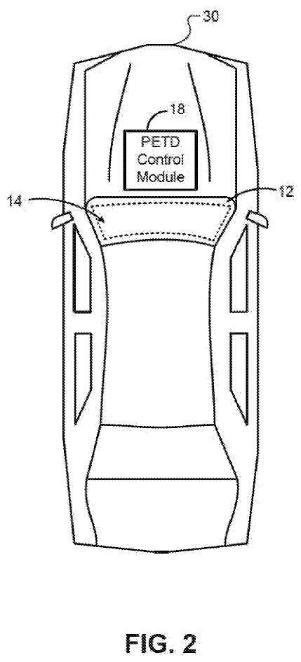

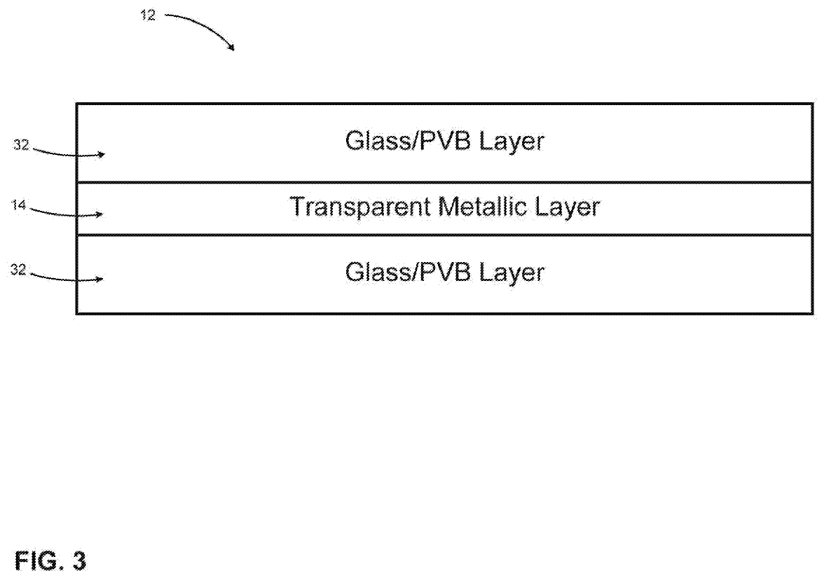

With reference to FIGS. 1-3, an exemplary PETD heater system 10 for a windshield 12 of a vehicle 30 is shown. The PETD heater system 10 includes a transparent metallic layer 14, also referred to as a transparent metallic sheet, embedded within the windshield 12. As shown in FIG. 3, the transparent metallic layer 14 can be sandwiched between one or more layers 32 of glass and/or polyvinyl butyral (PVB) shatter-resistant plastic. While the example of FIG. 3 includes a single transparent metallic layer 14 between layers 32 of glass or PVB, other configurations using additional transparent metallic layers 14 and/or additional glass or PVB layers can be used. The transparent metallic layer 14 in the windshield 12 can also be used to reflect infrared solar energy away from the interior of the vehicle 30.

The transparent metallic layer 14 is connected on opposite sides to bus bars 16, 17. While FIG. 1 shows the bus bars 16, 17 located on the left and right sides of the transparent metallic layer 14, the bus bars 16, 17 can alternatively be located on the top and bottom sides of the transparent metallic layer 14, or at other suitable locations. The bus bars 16, 17 are connected to a PETD control module 18 via wires 20, 21. The PETD control module 18 is connected to an electrical power supply 24 and a communication bus 26, such as a Controller Area Network (CAN) bus. The PETD control module 18 can, for example, be an electronic control unit (ECU) and can communicate with other ECUs and other devices or components of the vehicle 30 using the communication bus 26. The PETD control module 18 can be, and/or can include, a controller, a microcontroller, a microcomputer, or other computing device with a processor, memory, and/or other hardware and circuitry configured to control the PETD heater system 10 in accordance with the present disclosure.

The electrical power supply 24 can include one or more batteries of the vehicle 30. For example, in an electric vehicle the electrical power supply 24 can be a 400 to 900-volt battery. In a hybrid vehicle, the electrical power supply 24 can be a 36-volt battery. In an internal combustion engine vehicle, the electrical power supply 24 can be a 12-volt battery. While specific examples for batteries are provided, a battery of any suitable voltage can be used.

As shown in FIG. 1, wire 20 and bus bar 16 are shown as being on the positive terminal side and wire 21 and bus bar 17 are shown on the negative terminal side creating a voltage differential between the bus bars 16, 17 and allowing current to flow from the power supply 24 to the bus bars 16, 17 and across the transparent metallic layer 14. The control module 18 includes one or more switches, as necessary, to control and apply voltage to the wires 20, 21 and bus bars 16, 17. The voltage differential causes electrical current to flow across the transparent metallic layer 14, which heats the transparent metallic layer 14 and, in turn, heats the other layers of the windshield 12, such as the layers 32 of glass/PVB. The voltage applied to the bus bars 16, 17 and the transparent metallic layer 14 can be pulsed using a duty cycle or can be applied continuously until the PETD heater system 10 is turned off.

In this way, the PETD control module 18 controls the voltage applied to the bus bars 16, 17 and the flow of electrical current across the transparent metallic layer 14 to heat the windshield 12. As noted above, the heat from the windshield 12 can melt a thin layer of ice formed on the windshield 12 creating a thin layer of water between the windshield 12 and the remaining ice on the windshield 12. At that point, the windshield wipers of the vehicle 30 can be activated to brush the remaining ice off of the windshield 12. Similarly, the heat from the windshield 12 can also cause any fog or condensation formed on the windshield 12 to dissipate once the windshield 12 has been heated to above the current dew point of the environment of the vehicle 30.

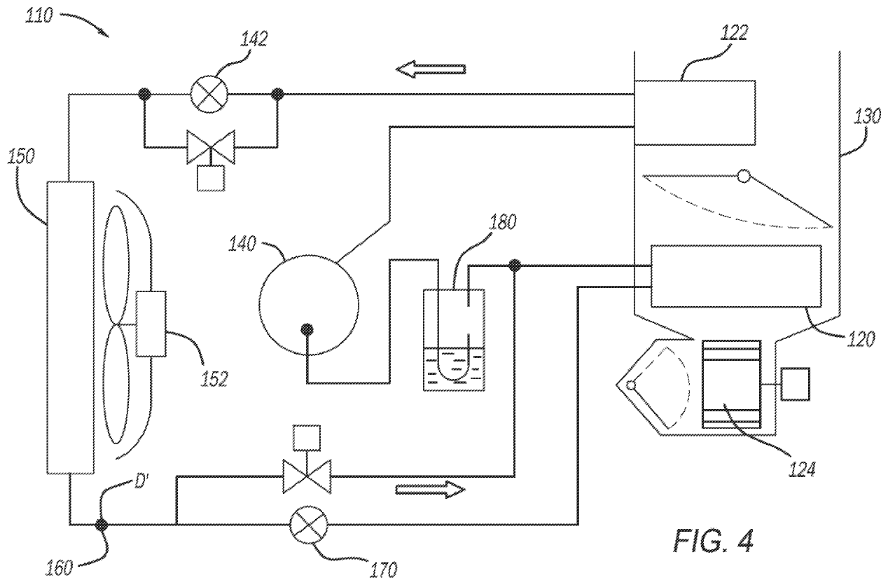

The PETD heater system 10 may also be configured to add heat to any suitable HVAC system to increase the overall efficiency and effectiveness of the HVAC system, such as when operated in a heating mode. For example, the PETD heater system 10 may be used to add heat to the HVAC system 110 of FIG. 4, which includes a heat pump. More specifically, the HVAC system 110 includes an evaporator 120 (or cooler core) and a cabin condenser 122 (or heater core) downstream of a blower 124 within an HVAC case 130. A compressor 140 compresses refrigerant, which flows through the cabin condenser 122 to an expansion valve 142. From the expansion valve 142, refrigerant flows across an outside heat exchanger (OHX) 150. A cooling fan 152 generates airflow across the OHX 150. Downstream of the OHX 150 is a sensor 160, which is configured to sense temperature and/or pressure of refrigerant exiting the OHX 150. Between the OHX 150 and the evaporator 120 is an evaporative expansion valve 170. Upstream of the compressor 140 is an accumulator 180.

The HVAC system 110 is controlled by the HVAC control module 50, which is in communication with the PETD control module 18 by way of the CAN bus 26. The PETD control module 18 is configured to apply voltage to the HVAC system 110 by connecting the power supply 24 to any suitable components of the HVAC system 110 in any suitable manner.

The PETD control module 18 includes one or more switches, as necessary, to control and apply voltage from the power supply 24 to any suitable metallic component of the HVAC system 110 by way of any suitable electrical connection. In response to a command from the HVAC control module 50, the PETD control module 18 is configured to apply a voltage to the metallic component of the HVAC system 110 to heat the metallic component. Voltage may be applied to the HVAC system 110 in any suitable manner, such as pulsed voltage, constant voltage, etc. The present disclosure is thus not limited to PETD control.

For example, the PETD control module 18 may be wired to any metallic manifold or conduit of the HVAC system 110 carrying refrigerant or coolant therethrough. In response to a command from the HVAC control module 50, the PETD control module 18 is configured to apply a voltage to the manifold or conduit of the HVAC system 110, which heats refrigerant or coolant flowing therethrough. Raising the temperature of the refrigerant or coolant increases the overall efficiency of the HVAC system 110 when in a heating mode. The manifold or conduit may include any suitable insulation layer, cover, etc. configured to retain heat and keep the heated refrigerant/coolant warm.

The PETD control module 18 may also be wired to metallic portions of the compressor 140, the cabin condenser 122, and/or a heater core of any suitable HVAC system, such as the HVAC system 110. In response to a command from the HVAC control module 50, the PETD control module 18 is configured to apply a voltage to the compressor 140, cabin condenser 122, and/or the heater core of the HVAC system 110. Applying a voltage to the compressor 140 heats the compressor, as well as the refrigerant therein to increase the temperature of the refrigerant and boost the efficiency of the HVAC system 110A when in a heating mode. Applying a voltage to the cabin condenser 122 (in a manner similar to a PTC heater) increases the temperature of the condenser coils, which are also heated by refrigerant flowing therethrough. Applying a voltage to the heater core (in a manner similar to a PTC heater) increases the temperature of the heater core coils, which are also heated by coolant flowing therethrough. Air blown across the condenser coils and heater core coils is thus heated not only by the refrigerant/coolant, but also by heat resulting from the voltage applied by the PETD control module 18, which gives a heat boost to the HAVC system 110 to increase the efficiency thereof. Voltage may be applied to the condenser 122 and heater core at the coils and/or tanks thereof.

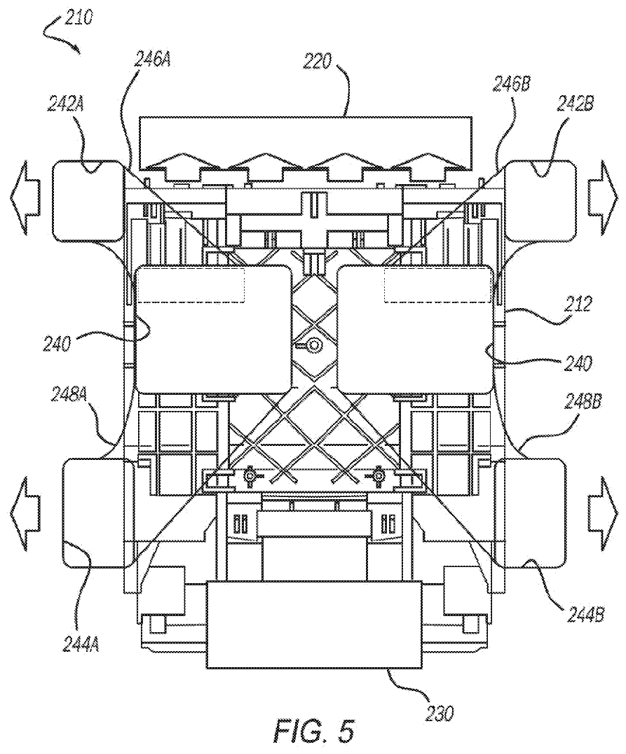

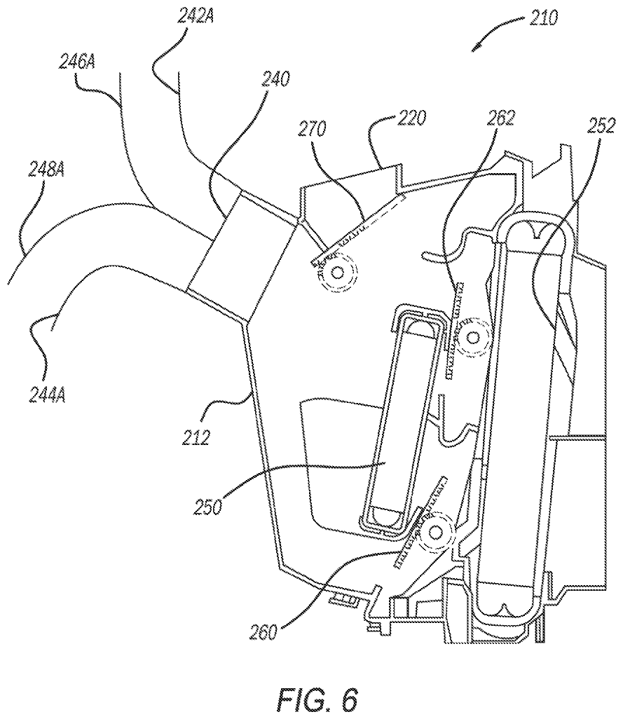

The PETD heater system 10 eliminates the need for defrost outlets in an HVAC case of the HVAC system 110, and HVAC outlets on the vehicle dashboard may be eliminated entirely. As a result, the HVAC case may be made smaller, which saves valuable space. FIGS. 5 and 6 illustrate an exemplary HVAC case 210 in which the defrost outlet has been eliminated. The HVAC case 210 may be incorporated into the HVAC system 110 of FIG. 4, or any other suitable HVAC system.

The HVAC case 210 includes a housing 212 defining various airflow outlets. The outlets includes a face outlet 220 and a rear outlet 230. The face outlet 220 is configured to direct airflow towards the face of a driver and any front seat occupant of the vehicle. The rear outlet 230 is connected by way of any suitable conduit(s) to a rear of the vehicle to deliver airflow to rear seat passengers. The HVAC housing 212, and the HVAC case 210 generally, does not define a defrost outlet.

The HVAC case 210 also defines a combined foot and side window outlet 240. In the example of FIGS. 5 and 6, the combined foot and side window outlet 240 is adjacent to the face outlet 220, and is defined generally at a rear of the HVAC case 210. The combined foot and side window outlet 240 may be split as illustrated in FIG. 5, or may be a single opening defined by the housing 212.

The combined foot and side window outlet 240 is generally a manifold, and is in fluid communication with a first side window opening 242A, a first foot opening 244A, a second side window opening 242B, and a second foot opening 244B. The combined foot and side window outlet 240 is connected to the first side window opening 242A with a first side window airflow conduit 246A, and is connected to the first foot opening 244A with a first foot airflow conduit 248A. The combined foot and side window outlet 240 is connected to the second side window opening 242B with a second side window airflow conduit 246B, and is connected to second foot opening 244B with a second foot airflow conduit 248B.

The first side window opening 242A is configured to direct airflow to a first side window of the vehicle 30, such as to a driver side window. The first side window opening 242A may also be configured to direct airflow towards the windshield 12. The second side window opening 242B is configured to direct airflow to a second side window of the vehicle 30, such as to a passenger side window. The second side window opening 242B may also be configured to direct airflow towards the windshield 12. The first foot opening 244A and the second foot opening 244B are configured to direct airflow towards the feet of a driver and a passenger respectively.

With particular reference to FIG. 6, the HVAC case 210 further includes a heater core 250 and an evaporator 252. Between the heater core 250 and the evaporator 252 is at least a first air mix door 260, which is configured to direct airflow from the evaporator 252 through or around the heater core 250. FIG. 6 includes a second air mix door 262, which is also between the heater core 250 and the evaporator 252. The second air mix door 262 is also configured to direct airflow from the evaporator 252 to or around the heater core 250.

The HVAC case 210 further includes a mode door 270. The mode door 270 is proximate to the face outlet 220 and the combined foot and side window outlet 240. The mode door 270 is movable to control airflow out of the HVAC case 210 through both the face outlet 220 and the combined foot and side window outlet 240. Thus, in accordance with the present disclosure, airflow through both the face outlet 220 and the combined foot and side window outlet 240 may be controlled by only a single door—the mode door 270. The mode door 270 is configured to be directly driven by a motor, such as a servo motor, without the need for one or more linkages. This configuration eliminates the need for separate mode doors at the face outlet 220, the combined foot and side window outlet 240, and a defrost outlet.

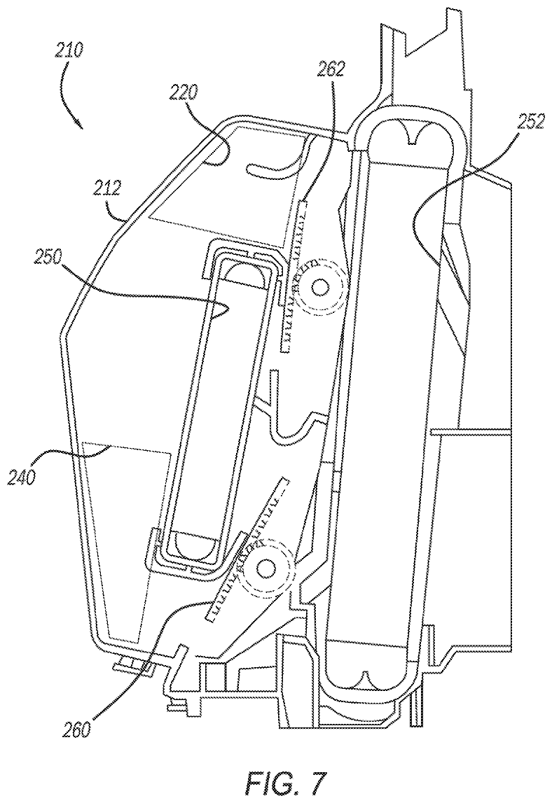

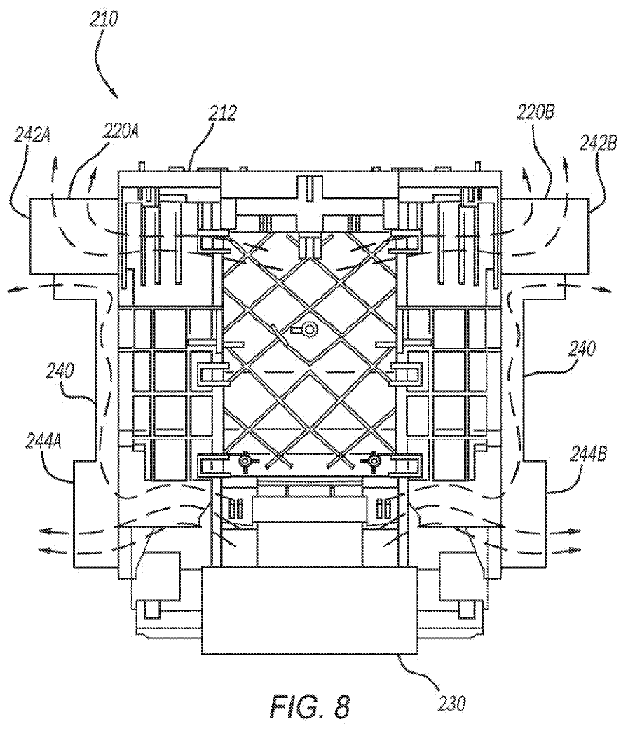

FIGS. 7 and 8 illustrate the HVAC case 210 modified to include the foot and side window manifold 240 at the sides of the HVAC case 210, rather than at the rear as illustrated in FIGS. 5 and 6. As illustrated in FIG. 7, the face outlet 220 is above the heater core 250, and the combined foot and side window outlet 240 is towards the bottom of the heater core 250. As illustrated in the configuration of FIG. 8, at left side of the HVAC case 210 is a left side of the foot and side window manifold 240, and on a right side of the HVAC case 210 is a right side of the foot and side window manifold 240. Airflow flows out of the HVAC case 210 into and through the foot and side window outlets 240 on the left and the right sides of the HVAC case 210. From the left outlet 240, airflow flows through the first foot opening 244A and the first side window opening 242A. From the right outlet 240, airflow flows through the second foot opening 244B and the second side window opening 242B.

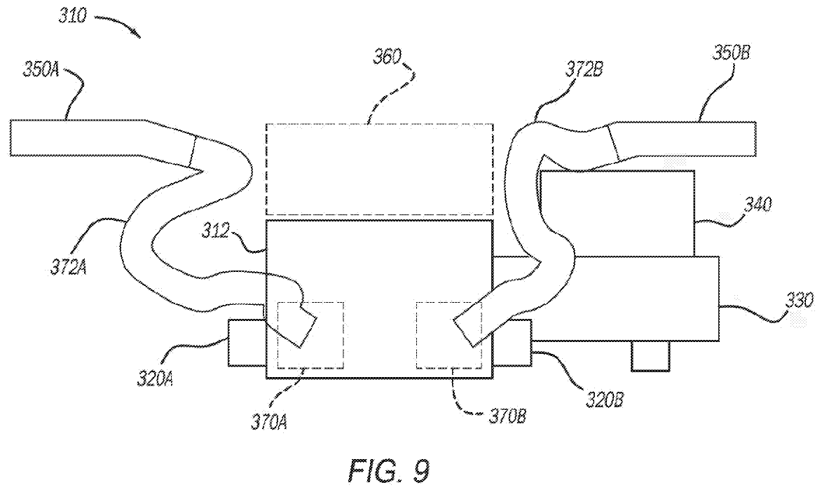

FIG. 9 illustrates an additional HVAC assembly 310 in accordance with the present disclosure. The HVAC assembly 310 includes an HVAC case 312, which defines a first foot outlet 320A and a second foot outlet 320B. The first and second foot outlets 320A and 320B are configured to direct airflow through associated conduits to a driver side footwell and a passenger side footwell respectively. Airflow is generated by a blower 330, which is associated with a inlet assembly 340 configured to selectively allow fresh outside air or recirc air into the blower 330.

The HVAC assembly 310 is configured to deliver airflow to a driver side window 350A and a passenger side window 350B. Airflow to the side windows 350A and 350B is often delivered by way of a windshield and side window defrost duct 360. But, the present disclosure defrosts the windshield 12 by heating the metallic layer 14, thus eliminating the need for the duct 360 to deliver warm air to the windshield 12. The duct 360 can be eliminated, which frees up valuable space behind the dashboard. In the absence of the duct 360, the HVAC assembly 310 may be retrofit by adding airflow outlets 370A and 370B, which are connected to the side window outlets 350A and 350B respectively. For example, the outlet 370A is connected to the side window outlet 350A by a first conduit 372A, and the outlet 370B is connected to the side window outlet 350B by a second conduit 372B. The conduits 372A and 372B may be any suitable flexible hose, for example.

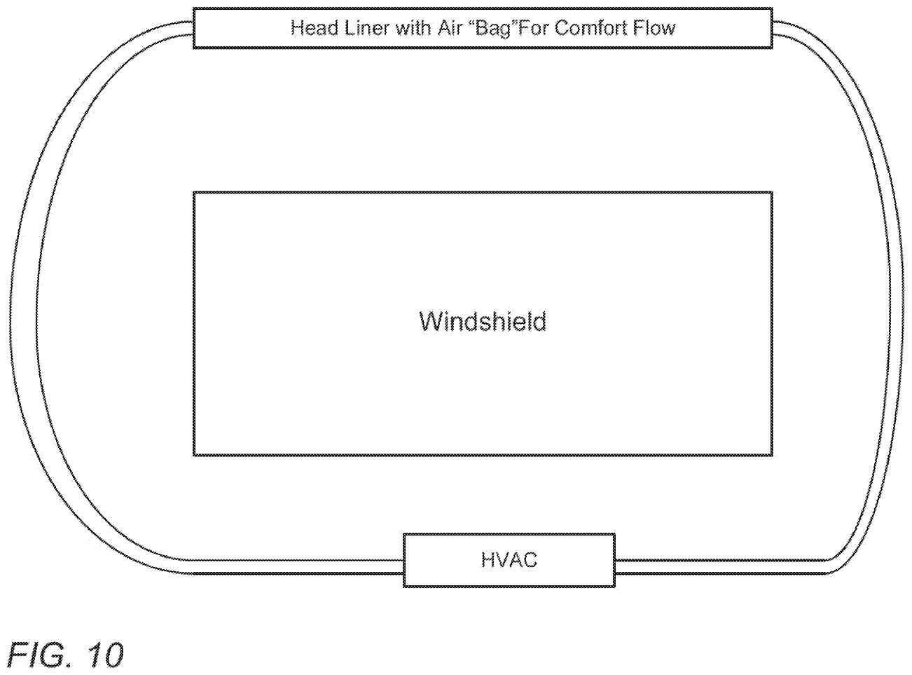

With reference to FIG. 10, the present disclosure further provides for a head liner 410 of the vehicle 30 including a “bag” or other receptacle, manifold, etc. configured to receive airflow from the HVAC case 210. The head liner 410 is in fluid cooperation with the HVAC case 210 in any suitable manner to receive airflow from the HVAC case 210. For example, any suitable airflow hose may be run from the HVAC case 210 through an A-pillar of the vehicle 30 to the head liner 410. The system of FIG. 10 is configured to deliver comfort flow to occupants of the vehicle 30 in the absence of defrost airflow being directed to the windshield 12. Comfort flow may “fall” from the area of the head liner 410 on occupants of the vehicle 30 to improve passenger comfort and counter cold or warm air fall off from the windshield.

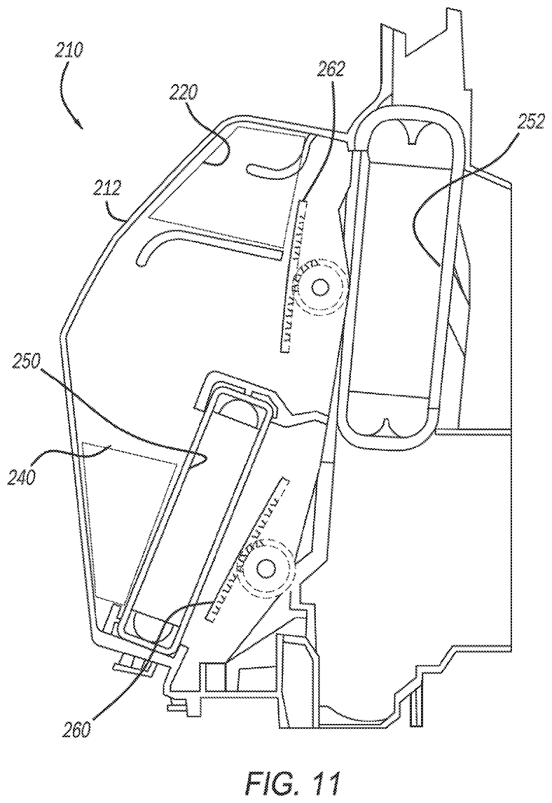

FIG. 11 illustrates the HVAC case 210 configured with the heater core 250 moved downward relative to the position of FIG. 7. In the configuration of FIG. 11, the heater core 250 is outside of an airflow path to the face outlet 220, and moved into general alignment with the foot and side window outlets 240. Due to the elimination of the defrost outlet, there is no need for warm airflow to the face outlet 220 or an upper area of the HVAC case 210 generally. Further, the size of the evaporator 252 may be reduced. For example, the length of the evaporator 252 may be shortened such that the bottom of the evaporator 252 is above, or generally even with, a top of the heater core 250. Thus, the evaporator 252 may be sized and positioned to be generally outside of an airflow path to the foot and side window outlets 240. The evaporator 252 and the door 262 are generally positioned such that the door 262 is configured to control all airflow through the evaporator 252.

The defrost outlet and associated function have been removed from the HVAC case 210, and the functionality has been replaced by the PETD control module 18 and the metallic layer 14. Therefore, at the upper portion of the HVAC case 210 only the face outlet 220 needs airflow. Face mode is a cooling mode, which does not require heating. Thus, the heater core 250 can be completely removed from the airflow pathway to the face outlet 220. The level of cooling to the face outlet 220 can be controlled in any suitable manner, such as by fan speed, compressor speed (via e-compressor), controlling/throttling refrigerant flow through the evaporator 252, via multitude of existing mechanical or electronic devices, as well as by any variation of internal HVAC door type, such as the door 262.

In the configuration of FIG. 11, occupant comfort can be improved because the removal of the heater core 250 from the upper door path increases the cross sectional area of the passageway dedicated to cool airflow (as compared to the configuration of FIG. 7, for example). Airflow volume in cooling modes is also improved. The pressure drop across the cooling passage (for cooling modes) will also be improved (pressure rise reduced) by eliminating resistance introduced by the presence of the heater core 250 in the standard design.

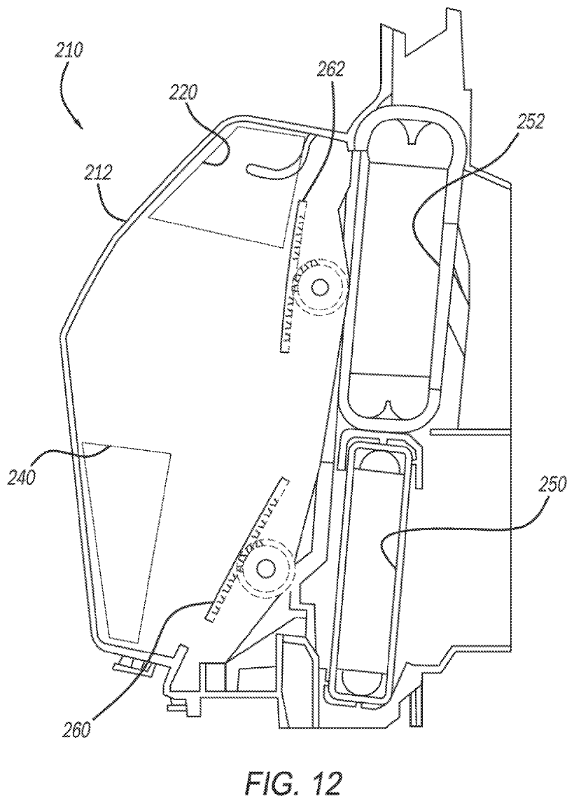

With reference to FIG. 12, the evaporator 252 and the heater core 250 may be vertically aligned, or generally aligned. For example, the evaporator 252 can be sized and positioned such that only airflow to the face outlet 220 passes therethrough. The heater core 250 may be sized and positioned such that only airflow to the foot and side window outlets 240 passes therethrough. The doors 260 and 262 may remain as separate doors, or replaced with a single door configured to direct airflow from the heater core 250 and the evaporator 252. This configuration effectively creates two distinct airflow paths. A cold airflow path through the evaporator 252 to the face outlet 220, and a warm airflow path through the heater core 250 to the foot and side window outlets 240.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. An HVAC system for a vehicle comprising:
a transparent metallic layer configured to be mounted to a windshield;
a control module configured to apply voltage from a power supply to the transparent metallic layer to heat the windshield; and
an HVAC case defining a face outlet and a combined foot and side window outlet, the HVAC case including a mode door movable to control airflow through both the face outlet and the combined foot and side window outlet.

2. The HVAC system of claim 1, wherein the transparent metallic layer is mounted to glass of the windshield.

3. The HVAC system of claim 1, wherein the control module is a pulse-electro thermal deicing (PETD) control module.

4. The HVAC system of claim 1, wherein the mode door is adjacent to the face outlet and the combined foot and side window outlet.

5. The HVAC system of claim 1, wherein the HVAC case is devoid of a windshield defrost outlet.

6. The HVAC system of claim 1, wherein the combined foot and side window outlet is in fluid communication with a side window opening by way of a first conduit, and in fluid communication with a foot opening by way of a second conduit.

7. The HVAC system of claim 6, wherein the side window opening is configured to direct airflow towards a side window of the vehicle and the windshield of the vehicle.

8. The HVAC system of claim 1, wherein the combined foot and side window outlet is at a rear of the HVAC case.

9. The HVAC system of claim 1, wherein the combined foot and side window outlet is at a side of the HVAC case.

10. The HVAC system of claim 1, wherein the HVAC case further defines an overhead outlet configured to cooperate with a head liner of the vehicle to deliver comfort airflow to a cabin of the vehicle.

11. The HVAC system of claim 1, the HVAC case further defining a rear outlet.

12. The HVAC system of claim 1, wherein the HVAC case further includes an evaporator, a heater core, a first air mix door between the evaporator and the heater core, and a second air mix door between the evaporator and the heater core.

13. The HVAC system of claim 1, wherein the evaporator and the heater core are vertically aligned.

14. An HVAC system for a vehicle comprising:
a transparent metallic layer mounted to a windshield;
a control module configured to apply voltage from a power supply to the transparent metallic layer to heat the windshield;
an HVAC case defining a face outlet and a combined foot and side window outlet that is adjacent to the face outlet;
a mode door opposite to the face outlet and the combined foot and side window outlet, the mode door movable to control airflow through both the face outlet and the combined foot and side window outlet;
an evaporator and a heater core within the HVAC case; and
at least one air mix door between the evaporator and the heater core.

15. The HVAC system of claim 14, wherein the control module is a pulse-electro thermal deicing (PETD) control module.

16. The HVAC system of claim 14, wherein the HVAC case is devoid of a windshield defrost outlet.

17. The HVAC system of claim 14, wherein the combined foot and side window outlet is in fluid communication with a first side window opening by way of a first conduit, and in fluid communication with a first foot opening by way of a second conduit.

18. An HVAC system for a vehicle comprising:
a transparent metallic layer mounted to a windshield;
a control module configured to apply voltage from a power supply to the transparent metallic layer to heat the windshield;
an HVAC case defining a face outlet and a combined foot and side window outlet that is adjacent to the face outlet;
a mode door opposite to the face outlet and the combined foot and side window outlet, the mode door movable to control airflow through both the face outlet and the combined foot and side window outlet;
an evaporator and a heater core within the HVAC case; and
at least one air mix door between the evaporator and the heater core;
wherein:
the combined foot and side window outlet is in fluid communication with a side window opening by way of a first conduit, and in fluid communication with a foot opening by way of a second conduit; and
the HVAC case is devoid of a windshield defrost outlet.

19. The HVAC system of claim 18, wherein the combined foot and side window outlet is at a rear of the HVAC case.

20. The HVAC system of claim 18, wherein the combined foot and side window outlet is at a side of the HVAC case.
